(19) United States
(12) Patent Application Publication
(10) Pub. No.: US 2026/0032466 A1
(43) Pub. Date: Jan. 29, 2026

(54) METHODS AND APPARATUSES FOR AI MODEL MANAGEMENT

(71) Applicant: Lenovo (Beijing) Limited, Beijing (CN)

(72) Inventors: Congchi Zhang, Shanghai (CN); Jianfeng Wang, Beijing (CN); Bingchao Liu, Beijing (CN); Shuigen Yang, Shanghai (CN); Mingzeng Dai, Shanghai (CN); Xin Guo, Beijing (CN)

(73) Assignee: Lenovo (Beijing) Limited, Beijing (CN)

(21) Appl. No.: 19/143,822

(22) PCT Filed: Jan. 12, 2023
(86) PCT No.: PCT/CN2023/071894

§ 371 Date: Jun. 26, 2025

(51) Int. Cl. H04W 24/02; H04W 76/27

(52) U.S. Cl. CPC H04W 24/02; H04W 76/27

(57) ABSTRACT

Embodiments of the present application relate to methods and apparatuses for artificial intelligence (AI) model management. According to an embodiment of the present application, a network node includes a processor and a transceiver coupled to the processor; and the processor is configured to: receive, via the transceiver, information related to a set of artificial intelligence (AI) models available at a user equipment (UE); and transmit, via the transceiver, information indicating at least one of the following: information of an AI model that is not included in the set of AI models; or handling the set of AI models.

### TECHNICAL FIELD

Embodiments of the present application are related to wireless communication technology, especially, related to methods and apparatuses for artificial intelligence (AI) model management.

### BACKGROUND

Artificial Intelligence (AI)/Machine Learning (ML) is used to learn and perform certain tasks by training the AI/ML models such as neural networks (NNs) with vast amounts of data, which is successfully applied in computer vison (CV) and nature language processing (NLP) areas. Deep learning (DL), which is a subordinate concept of ML, utilizes multi-layered NNs as an “AI model” to learn how to solve problems and/or optimize performance from vast amounts of data. An AI model may also be named as an AIML model, an AI/ML model, or the like.

With the development of 3rd generation partnership program (3GPP) 5G networks, various aspects need to be studied and developed to perfect the 5G technology. Currently, details regarding methods and apparatuses for AI model management have not been discussed in 3GPP 5G technology yet.

### SUMMARY

Some embodiments of the present application provide a network node. The network node includes a transceiver; and a processor coupled to the transceiver, wherein the processor is configured to: receive, via the transceiver, first information related to a set of artificial intelligence (AI) models available at a user equipment (UE); and transmit, via the transceiver, second information indicating at least one of the following: information of an AI model that is not included in the set of AI models; or handling the set of AI models.

In some embodiments, the AI model that is not included in the set of AI models is a default AI model, or an AI model updated based on a corresponding default AI model; and in the case that the AI model that is not included in the set of AI models is the AI model updated based on the corresponding default AI model, the second information further comprises an updated part of the AI model that is not included in the set of AI models.

In some embodiments, before transmitting the second information, the processor is configured to decide how to handle an AI model based on a capability of the UE.

In some embodiments, the capability of the UE includes a maximum memory size that the UE can use to keep AI models.

In some embodiments, the processor is configured to transmit a request for the first information via the transceiver to the UE.

In some embodiments, the request is a UE information request message, a first RRC message, or a UE capability request message, and the first information is included in a UE information response message, a second RRC message, or an indication of a capability of the UE.

In some embodiments, the first information is received from a core network (CN) in the case that the UE enters an RRC connected state from an RRC idle state.

In some embodiments, the first information is received from another network node.

In some embodiments, the first information includes a model identifier (ID) or a model index of an AI model within the set of AI models.

In some embodiments, in the case that the AI model within the set of AI model is an AI model updated based on a corresponding default AI model, the first information further includes an updated part of the AI model.

In some embodiments, in the case that the second information indicates handling the set of AI models, the second information indicates at least one of the following: keeping an AI model within the set of AI models; updating an AI model within the set of AI models; deleting an AI model within the set of AI models; or falling back an AI model within the set of AI models to a corresponding default AI model.

In some embodiments, the keeping an AI model within the set of AI models further includes: keeping all of the set of AI models; or keeping one or more AI models within the set of AI models; the updating an AI model within the set of AI models further includes: updating all of the set of AI models; or updating one or more AI models within the set of AI models; the deleting an AI model within the set of AI models further includes: deleting all of the set of AI models; or deleting one or more AI models within the set of AI models; and the falling back an AI model updated within the set of AI models to a corresponding default AI model further includes: falling back all AI model(s) updated within the set of AI models to corresponding default AI model(s) respectively; or falling back one or more AI models updated within the set of AI models to one or more corresponding default AI models respectively.

In some embodiments, in the case that the second information indicates keeping or updating or falling back an AI model within the set of AI models, the second information further indicates at least one of the following: a time period to maintain a remained AI model corresponding to the AI model; or one or more cell IDs, to which the remained AI model is applicable.

In some embodiments, in the case that the second information indicates the updating an AI model within the set of AI models, the second information further indicates an updated part to be applied to each of the one or more AI models.

In some embodiments, the second information further indicates one or more model IDs or model indexes of the one or more AI models.

In some embodiments, a default model is identified by a dedicated model ID or a dedicated model index, and any AI model updated based on the default AI model is identified by the dedicated model ID or the dedicated model index that has been used to identify the default AI mode.

In some embodiments, the processor is configured to receive, via the transceiver from the UE, information to confirm that one or more AI models at the UE are ready to be used according to the second information.

In some embodiments, the processor is configured to transmit, via the transceiver to the UE, an indication to activate a subset of AI models within the one or more AI models.

In some embodiments, the processor is configured to transmit, via the transceiver to the UE, one or more model IDs or model indexes of one or more AI models that are expected to be used by the UE.

In some embodiments, the second information is included in an RRC message to instruct the UE to enter an RRC inactive state or an RRC idle state from an RRC connected state.

Some embodiments of the present application also provide a network node. The network node includes a transceiver; and a processor coupled to the transceiver, wherein the processor is configured to receive first information related to an artificial intelligence (AI) model available at a user equipment (UE) via the transceiver from the UE, wherein the first information includes a model identifier (ID) or a model index of the AI model.

In some embodiments, the first information further includes any of the following: an updated part of the AI model updated based on a corresponding default AI model; or an indication for indicating that the UE decides to fall back the AI model to the corresponding default AI model.

In some embodiments, the processor is configured to transmit information, via the transceiver to the UE, to confirm that the UE is allowed to use one or more AI models which are ready to be used.

In some embodiments, the processor is configured to receive, via the transceiver from the UE, information to indicate that the one or more AI models are ready to be used.

Some embodiments of the present application provide a user equipment (UE). The UE includes a transceiver; and a processor coupled to the transceiver, wherein the processor is configured to transmit, via the transceiver to a network node, first information related to a set of artificial intelligence (AI) models available at the UE; and receive, via the transceiver, second information indicating at least one of the following from the network node: information of an AI model that is not included in the set of AI models; or handling the set of AI models.

In some embodiments, the AI model that is not included in the set of AI models is a default AI model, or an AI model updated based on a corresponding default AI model; and in the case that the AI model that is not included in the set of AI models is the AI model updated based on the corresponding default AI model, the second information further comprises an updated part of the AI model that is not included in the set of AI models.

In some embodiments, the processor is configured to transmit, via the transceiver to the network node, an indication for indicating a capability of the UE, and the capability of the UE includes a maximum memory size that the UE can keep AI models.

In some embodiments, the processor is configured to receive a request for the first information via the transceiver from the network node.

In some embodiments, the request is a UE information request message, a first radio resource control (RRC) message, or a UE capability request message, and the first information is included in a UE information response message, a second RRC message, or an indication of a capability of the UE.

In some embodiments, the first information includes a model identifier (ID) or a model index of an AI model within the set of AI models.

In some embodiments, in the case that the second information indicates handling the set of AI models, the second information includes at least one of the following: keeping an AI model within the set of AI models; updating an AI model within the set of AI models; deleting an AI model within the set of AI models; or falling back an AI model within the set of AI models to a corresponding default AI model.

In some embodiments, the keeping an AI model within the set of AI models further includes: keeping all of the set of AI models; or keeping one or more AI models within the set of AI models; the updating an AI model within the set of AI models further includes: updating all of the set of AI models; or updating one or more AI models within the set of AI models; the deleting an AI model within the set of AI models further includes: deleting all of the set of AI models; or deleting one or more AI models within the set of AI models; and the falling back an AI model updated within the set of AI models to a corresponding default AI model further includes: falling back all AI model(s) updated within the set of AI models to corresponding default AI model(s) respectively; or falling back one or more AI models updated within the set of AI models to one or more corresponding default AI models respectively.

In some embodiments, in the case that the second information indicates keeping or updating or falling back an AI model within the set of AI models, the second information further indicates at least one of the following: a time period to maintain a remained AI model corresponding to the AI model; or one or more cell IDs, to which the remained AI model is applicable.

In some embodiments, in the case that the second information indicates the updating an AI model within the set of AI models, the second information further indicates an updated part to be applied to each of the one or more AI models.

In some embodiments, the second information further indicates one or more model IDs or model indexes of the one or more AI models.

In some embodiments, the processor is configured to transmit, via the transceiver to the network node, information to indicate that one or more AI models at the UE are ready to be used.

In some embodiments, the information includes a model ID or a model index of each of the one or more AI models.

In some embodiments, the processor is configured to receive, via the transceiver from the network node, an indication to activate a subset of AI models within the one or more AI models.

In some embodiments, the processor is configured to receive, via the transceiver from the network node, one or more model IDs or model indexes of one or more AI models that are expected to be used by the UE.

In some embodiments, the second information is included in an RRC message to instruct the UE to enter an RRC inactive state or an RRC idle state from an RRC connected state.

In some embodiments, a default AI model and an AI model based on the default AI model have a same model ID or a same model index.

In some embodiments, for one or more AI models available at the UE but not indicated in the second information, the processor is configured to: decide whether to keep, update, delete, or fallback the one or more AI models upon an implementation of the UE; keep all of the one or more AI models by default; update all of the one or more AI models by default; delete all of the one or more AI models by default; or fallback all of the one or more AI models to default AI models.

Some embodiments of the present application also provide a user equipment (UE). The UE includes a transceiver; and a processor coupled to the transceiver, wherein the processor is configured to transmit first information related to an artificial intelligence (AI) model available at the UE via the transceiver to a network node, wherein the first information includes a model identifier (ID) or a model index of the AI model.

In some embodiments, the first information further includes at least one of the following: an updated part of the AI model updated based on a corresponding default AI model; or an indication for indicating that the UE decides to fall back the AI model to the corresponding default AI model.

In some embodiments, the processor is configured to receive, via the transceiver from the network node, information to confirm that the UE is allowed to use one or more AI models which are ready to be used.

In some embodiments, the processor is configured to transmit, via the transceiver to the network node, information to indicate that the one or more AI models are ready to be used.

Some embodiments of the present application provide a method, which may be performed by a network node. The method includes: receiving first information related to a set of artificial intelligence (AI) models available at a user equipment (UE); and transmitting second information indicating at least one of the following: information of an AI model that is not included in the set of AI models; or handling the set of AI models.

Some embodiments of the present application provide a method, which may be performed by a network node. The method includes: receiving first information related to an artificial intelligence (AI) model available at a user equipment (UE) from the UE, wherein the first information includes a model identifier (ID) or a model index of the AI model.

Some embodiments of the present application provide a method, which may be performed by a user equipment (UE). The method includes: transmitting first information related to a set of artificial intelligence (AI) models available at the UE to a network node; and receiving second information indicating at least one of the following from the network node: information of an AI model that is not included in the set of AI models; or handling the set of AI models.

Some embodiments of the present application provide a method, which may be performed by a user equipment (UE). The method includes: transmitting first information related to an artificial intelligence (AI) model available at the UE to a network node, wherein the first information includes a model identifier (ID) or a model index of the AI model.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a DU or CU.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates a schematic diagram of a wireless communication system according to some embodiments of the present application.

FIG. 2 illustrates an exemplary diagram of an AI model scenario according to some embodiments of the present application.

FIG. 3 illustrates an exemplary flowchart for AI model management according to some embodiments of the present application.

FIG. 4 illustrates another exemplary flowchart for AI model management according to some embodiments of the present application.

FIGS. 5-8 illustrate flowcharts of exemplary procedures for AI model management according to some embodiments of the present application.

FIG. 9 illustrates a block diagram of an exemplary apparatus in accordance with some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with the developments of network architectures and new service scenarios, all embodiments in the present application are also applicable to similar technical problems. Moreover, the terminologies recited in the present application may change, which should not affect the principle of the present application.

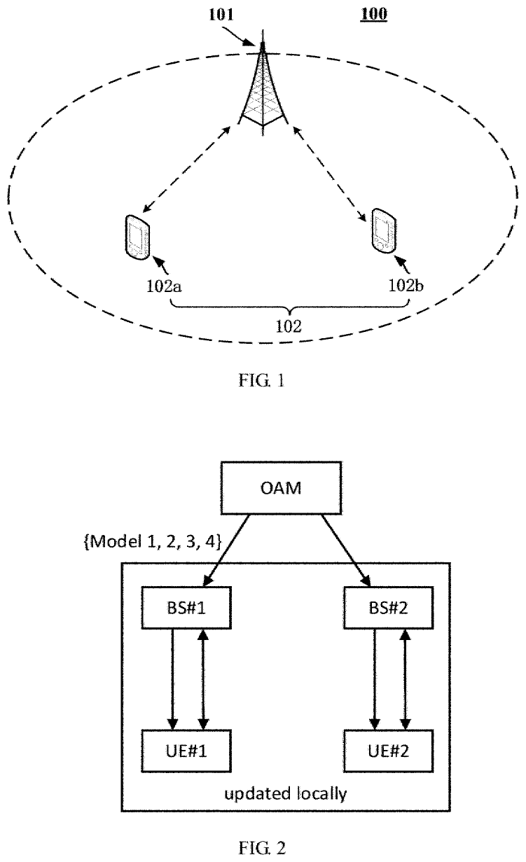

FIG. 1 illustrates a schematic diagram of a wireless communication system according to some embodiments of the present application.

As shown in FIG. 1, the wireless communication system 100 includes at least one BS 101 and at least one UE 102. In particular, the wireless communication system 100 includes one BS 101 and two UE 102 (e.g. UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g. a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g. during a handover procedure for a UE.

UE 102, e.g. UE 102a and UE 102b, should be understood as any type terminal device, which may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In general, AI/ML is used to learn and perform certain tasks via training AI/ML models such as neural networks with vast amounts of data, which is successfully applied in computer vison (CV) and nature language processing (NLP) areas. As the subset of ML, Deep Learning (DL) utilizes multi-layered neural networks (NN) as the “AI model” to learn solving problems and optimize performance from vast amounts of data. According to agreements of the current 3GPP radio access network (RAN) Rel-18, An AI/ML model can be used to optimize UE and RAN operation in access stratum (AS).

Currently, issues of AI model management in several cases have not been solved, for example: in a case that a UE is transferred from an RRC connected state to an RRC inactive or idle state, whether the UE should keep the default models and/or the updated models; in a case that a BS transfers default model(s) to a UE in an RRC connected state, how can the BS knows which default model(s) is already available at the UE, and thus does not require transferring the default model(s) over Uu interface again; in a UE initiated model update or a BS initiated model update (e.g. finetuning or adaptation), what needs to be transferred with respect to model finetuning or updating; and in a handover procedure, what needs to be exchanged between a source BS and a target BS. In summary, there is a need to design a mechanism that can ensure the consistency of available AI model, among UE, its serving BS, and even the core network.

To solve the above mentioned issues, embodiments of the present application aim to provide signaling procedures to support AI model management. In some embodiments of the present application, a BS gives an instruction of AI model management in the RRC release message when instructing the UE to an RRC inactive or idle state. In some embodiments of the present application, a UE informs a BS about default model(s) that are already available at the UE. In some embodiments of the present application, a model ID or a model index and an updated part (delta part) on top of a default model, as well as a new indicator can be used when a BS wants to fallback an updated or finetuned model to the default model. In some embodiments of the present application, a source BS indicates the available default model(s) at a UE, and a target BS may further instruct the UE to finetune or update the model on top of the default model. More details will be illustrated in following text in combination with the appended drawings.

FIG. 2 illustrates an exemplary diagram of an AI model scenario according to some embodiments of the present application. In the embodiments of FIG. 2, an operator or an operation administration and maintenance (OAM) maintains a set of UE sided AI/ML models (i.e. single sided model(s)) or two-sided AI/ML models, e.g. {Model 1, 2, 3, 4} as shown in FIG. 2. These AI/ML models can be offline trained by OAM, provided by the network vendors or UE vendors, or provided by a third party. These AI/ML models may be default models. A default AI/ML model may also be named as “a fundamental model”, “a basic model”, “a root model” or the like. A default AI/ML model may include a default AI/ML model structure (e.g. different layers in a deep learning model) and default parameters, which can be further locally updated or modified or finetuned by a BS (e.g. gNB) or a UE to better fit the actual situation. An AI/ML model which is updated based on a corresponding default AI model is identified by the same model ID or the same model index that has been used to identify the corresponding default AI/ML model.

For instance, a set of default AI/ML models may be given to one or more BSs within the same public land mobile network (PLMN). Each default AI/ML model may be identified by a globally unique Model ID. In some embodiments, a default AI/ML model list may include:
Model 1: A default AI/ML model for temporal CSI prediction
Model 2: A default AI/ML model for CSI feedback compression
Model 3: A default AI/ML model for temporal beam prediction
Model 4: A default AI/ML model for spatial beam prediction

In the embodiments of FIG. 2, OAM may train and store an AI model per use case, per functionality, per UE type or UE group, per frequency or carrier, or per cell or area. A BS (e.g. BS #1 and BS #2 as shown in FIG. 2) may transmit the AI model to UE according to the actual situation, and may further tell the UE about the condition that the UE can use the model. The UE (e.g. UE #1 and UE #2 as shown in FIG. 2) can receive default AI/ML model(s) from the BS, when needed. The UE or the BS can further locally update or finetune the AI/ML model(s) based on local monitoring, e.g. adjusting some parameters or weights values.

In the embodiments of the present application, AI/ML models are referred to those AI/ML models used by a UE, i.e. either a (single) UE sided model that the inference is performed at the UE or a two-sided model that inference is performed at both the UE and a BS, to optimize at least the physical layer operation such as temporal CSI prediction, CSI feedback compression, temporal beam prediction, or spatial beam prediction. Each AI/ML model may be identified by a Model ID or a Model Index.

In some embodiments of the present application, an AI/ML model is used for channel state information (CSI) feedback enhancement, for example: (1) spatial-frequency domain CSI compression using a two-sided AI model; and (2) time domain CSI prediction using a UE sided model. For example, in CSI feedback compression, a UE uses sub-model A to compress CSI feedback, a BS uses sub-model B to decompress CSI feedback.

In some further embodiments of the present application, an AI/ML model is used for beam management, for example: (1) spatial-domain DL beam prediction for one set (e.g. Set A) of beams based on measurement results of another set (e.g. Set B) of beams; and (2) temporal DL beam prediction for Set A of beams based on the historic measurement results of Set B of beams.

In some another embodiments of the present application, an AI/ML model is used for positioning accuracy enhancements for different scenarios, direct AI/ML positioning, and AI/ML assisted positioning.

In the embodiments of the present application, an AI/ML model which is updated based on a corresponding default AI model is identified by the same model ID or the same model index that has been used to identify the corresponding default AI/ML model. The default model and the mapping between Model ID and its relevant default model may be deployed by OAM to all BSs under its control in advance, such that the BSs belonging to the same PLMN have the same understanding on Model ID and its relevant default model and UE can retrieve the default model from gNB directly.

The embodiments of the present application assume that AI/ML model(s) used by a UE is managed by a BS (e.g. gNB). It can be transferred from the BS directly, or transferred by other network entities (e.g. CN node, or OAM) and the BS is fully aware of (e.g. via OAM configuration).

In the embodiments of the present application, an AI/ML model may also be named as “an AI model”, “a ML model”, “an AI-ML model” or the like. A default model may be identified by a dedicated model ID or a dedicated model index. An AI model updated based on a corresponding default AI model is identified by the dedicated model ID or the dedicated model index that has been used to identify the default AI mode.

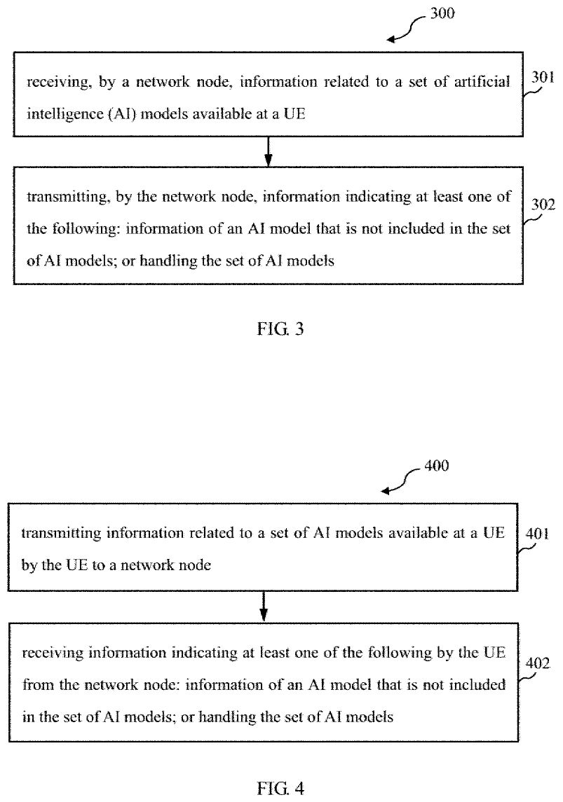

FIG. 3 illustrates an exemplary flowchart for AI model management according to some embodiments of the present application. The exemplary method 300 in the embodiments of FIG. 3 may be performed by a network node, for example, a BS (e.g. BS 101, BS 502, BS 602, or target BS 703 as shown in any of FIGS. 1 and 5-7). Although described with respect to a network node, it should be understood that other devices may be configured to perform a method similar to that of FIG. 3.

In the exemplary method 300 as shown in FIG. 3, in operation 301, a network node may receive information (denoted as information #1 for simplicity) related to a set of AI models available at a UE.

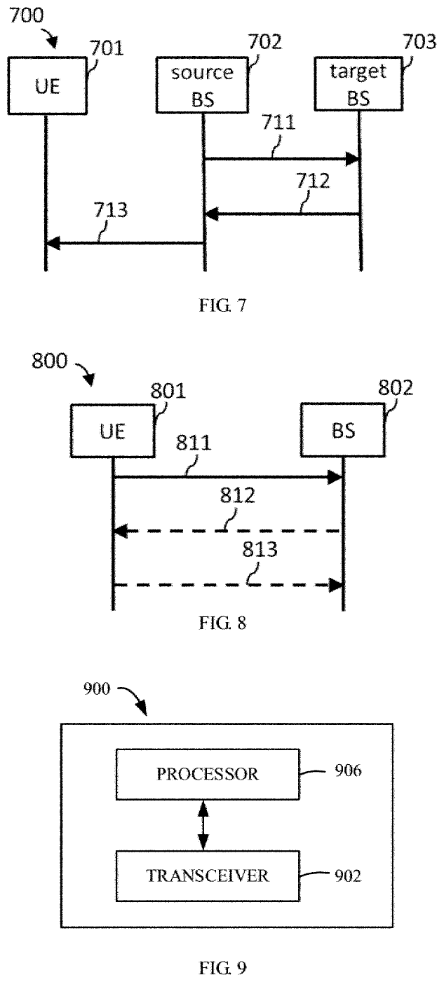

In an embodiment, the network node may transmit a request for information #1 to the UE. In an embodiment, the request is a UE information request message, an RRC message, or a UE capability request message. Information #1 may be included in a UE information response message, an RRC message, or an indication of a capability of the UE. In a further embodiment, information #1 is received from a core network (CN) in the case that the UE enters an RRC connected state from an RRC idle state. In another embodiment, information #1 is received by the network node (e.g. target BS 702 as shown in FIG. 7) from another network node (e.g. source BS 702 as shown in FIG. 7). Specific examples are described in embodiments of FIGS. 6 and 7 as follows.

In some embodiments, information #1 includes a model ID or a model index of an AI model within the set of AI models. Comparing with the model ID, which is a globally unique ID in the scope of a PLMN, the model index can be regarded as a local ID shared by UE and its corresponding BS. In some embodiments, in the case that the AI model within the set of AI model is an AI model updated based on a corresponding default AI model, information #1 further includes an updated part of the AI model.

In operation 302, the network node may transmit information (denoted as information #2 for simplicity) indicating at least one of: (1) information of an AI model that is not included in the set of AI models; or (2) handling the set of AI models.

The AI model that is not included in the set of AI models may also be denoted as “an unavailable AI model”, “a new AI model” or the like. In some embodiments, the unavailable AI model is a default AI model, or an AI model updated based on a corresponding default AI model (denoted as “an updated AI model”). In the case that the unavailable AI model is a default AI model, the information of the unavailable AI model may include parameter(s) of default AI model(s) that is not available at the UE. For instance, the network node may transfer “all parameters(s) of default AI model(s) that is not available at the UE” to the UE in operation 302. In the case that the unavailable AI model is the updated AI model, information #2 further includes an updated part of the unavailable AI model.

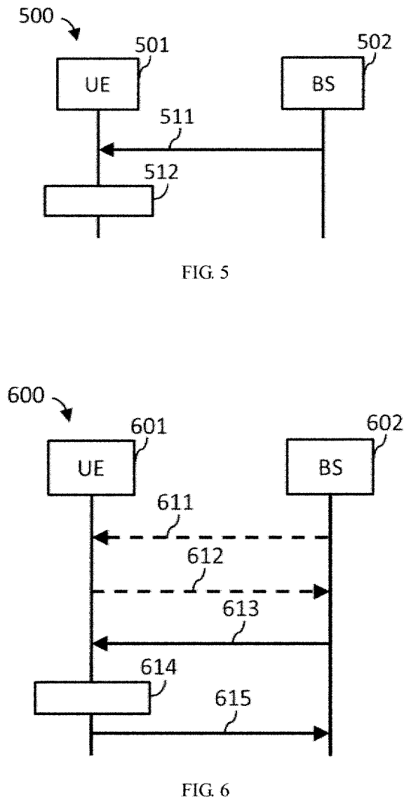

In some embodiments, information #2 is included in an RRC message (e.g. an RRC release message) to instruct the UE to enter an RRC inactive state or an RRC idle state from an RRC connected state. Specific examples are described in embodiments of FIG. 5 as follows.

In some embodiments, before transmitting information #2, the network node may decide how to handle an AI model based on a capability of the UE. In an embodiment, the capability of the UE includes a maximum memory size that the UE can use to keep AI models.

In some embodiments, information #2 includes a model ID or a model index of an AI model which is included or not included in the set of AI models.

In some embodiments, in the case that information #2 indicates handling the set of AI models, information #2 indicates at least one of the following:
(1) Keeping an AI model within the set of AI models. In an embodiment, the keeping further includes:
   a) keeping all of the set of AI models; or
   b) keeping one or more AI models within the set of AI models. The one or more AI models are denoted as “AI model subset #1” for simplicity.
(2) Updating an AI model within the set of AI models. In an embodiment, the updating further includes:
   a) updating all of the set of AI models; or
   b) updating one or more AI models (denoted as AI model subset #2) within the set of AI models.
(3) Deleting an AI model within the set of AI models. In an embodiment, the deleting further includes:
   a) deleting all of the set of AI models; or
   b) deleting one or more AI models (denoted as AI model subset #3) within the set of AI models.
(4) Falling back an AI model updated within the set of AI models to a corresponding default AI model. In an embodiment, the falling back further includes:
   a) falling back all updated AI model(s) within the set of AI models to corresponding default AI model(s) respectively; or
   b) falling back one or more updated AI models (denoted as AI model subset #4) within the set of AI models to one or more corresponding default AI models respectively.

In some embodiments, in the case that information #2 indicates keeping or updating or falling back an AI model within the set of AI models available at the UE, information #2 further indicates at least one of:
(1) A time period to maintain a remained AI model corresponding to the AI model. In case that information #2 indicates keeping an AI model, the remained AI model is the AI model (e.g. within AI model subset #1) indicated in information #1. In case that information #2 indicates updating an AI model, the remained AI model is an updated AI model based on the AI model (e.g. within AI model subset #2) indicated in information #1, or based on a corresponding default AI model of the AI model (e.g. within AI model subset #2) indicated in information #1. In case that information #2 indicates falling back an AI model, the remained AI model is a corresponding default AI model of the AI model (e.g. within AI model subset #4) indicated in information #1. A remained AI model may also be named as an AI model which has been handled by the UE.
(2) One or more cell IDs, to which the remained AI model is applicable. For example, information #2 indicates one or more cell IDs of certain cells, if the UE connects to such cells when entering an RRC connected state again.

In some embodiments, in the case that information #2 indicates the updating an AI model within the set of AI models, information #2 further indicates an updated part to be applied to each AI model within AI model subset #2. In an embodiment, information #2 further indicates one or more model IDs or model indexes of AI model subset #2.

In some embodiments, information #2 may include particular model ID(s) or index(es) or both, of AI model(s) to be kept or updated or deleted or fallen back. In some further embodiments, information #1 includes the particular model ID and/or model index of each AI model (including default AI models and updated AI models). Correspondingly, information #2 may include the model ID, the model index, or both, or neither includes the model ID nor the model index, depending on the handling of each AI models included in information #1 or if a new AI model being included in information #2. In such further embodiments, information #2 can include a bitmap or string to indicate the handling of each AI model. In a first example, if the UE deploys 5 AI models with an index from 0 to 4, information #2 may include a string “00123” to indicate the handling of each AI model. Wherein, the Least Significant Bit (LSB) refers to a model with an index of 0 while the Most Significant Bit (MSB) refers to a model with an index of 4, and the value of bit indicates the handling of model, for example, 0 refers to “keep”, 1 refers to “update”, 2 refers to “delete”, and 3 refers to “fallback”. Therefore, information #2 indicates that the UE should keep the models with indexes of 4 and 3, update the model with an index of 2, delete the model with an index of 1, and fallback the model with an index of 0. And further, regarding to the model with an index of 2, information #2 includes the updated part of the model along with the model ID or the model index (i.e. 2) of the model. In a second example, if information #2 includes a bitmap or a string of “00323”, information #2 indicates that the UE should keep the models with indexes of 4 and 3, delete the model with an index of 1, and fallback the model with an index of 2 and 0. Obviously, information #2 is not necessary to include any of model IDs or model indexes, given that there is no models to be updated with detailed information. In a third example, information #2 indicates a new model that is not included in the set of AI models from information #1. Obviously, information #2 shall indicate the model ID of the new model, and optionally assign a model index for the new model, given that the new AI model is not indexed from the perspective of UE.

In some embodiments, the network node may receive, from the UE, information to confirm that one or more AI models at the UE are ready to be used according to the second information. In an embodiment, the network node may transmit, to the UE, an indication to activate a subset of AI models within the one or more AI models.

In some embodiments, the network node may transmit, to the UE, one or more model IDs or model indexes of one or more AI models that are expected to be used by the UE. Specific examples are described in embodiments of FIGS. 6 and 7 as follows.

It should be appreciated by persons skilled in the art that the sequence of the operations in exemplary procedure 300 may be changed and some of the operations in exemplary procedure 300 may be eliminated or modified, without departing from the spirit and scope of the disclosure. Details described in all other embodiments of the present application are applicable for the embodiments of FIG. 3. Moreover, details described in the embodiments of FIG. 3 are applicable for all the embodiments of FIGS. 1 and 4-9.

FIG. 4 illustrates another exemplary flowchart for AI model management according to some embodiments of the present application. The exemplary method 400 in the embodiments of FIG. 4 may be performed by a UE (e.g. UE 102, UE 501, UE 601, or UE 701 as shown in any of FIGS. 1 and 5-7). Although described with respect to a UE, it should be understood that other devices may be configured to perform a method similar to that of FIG. 4.

In the exemplary method 400 as shown in FIG. 4, in operation 401, a UE may transmit information (e.g. information #1 as described in the embodiments of FIG. 3) related to a set of AI models available at the UE to a network node. In operation 402, the UE may receive information (e.g. information #2 as described in the embodiments of FIG. 3), which indicates at least one of (1) information of an AI model that is not included in the set of AI models or (2) handling the set of AI models, from the network node.

In some embodiments, the AI model (denoted as “an unavailable AI model”) that is not included in the set of AI models is a default AI model, or an AI model updated based on a corresponding default AI model (denoted as “an updated AI model”). In the case that the unavailable AI model is the updated AI model, information #2 received from the network node further comprises an updated part of the AI model that is not included in the set of AI models.

In some embodiments, the UE may transmit an indication for indicating a capability of the UE to the network node. The capability of the UE may include a maximum memory size that the UE can keep AI models.

In some embodiments, the UE may receive a request for information #1 from the network node. In an embodiment, the request is a UE information request message, an RRC message, or a UE capability request message, and information #1 is included in a UE information response message, an RRC message, or an indication of a capability of the UE.

In some embodiments, information #1 includes a model ID or a model index of an AI model within the set of AI models. In some embodiments, information #1 further includes at least one of the following:
(1) one or more updated parts of one or more AI models within the set of AI models updated based on one or more corresponding default AI models;
(2) one or more model IDs or model indexes of the one or more AI models; or
(3) one or more model IDs or model indexes of a set of AI models which have been updated and are expected to be used by the UE in future within the set of AI models.

In some embodiments, information #2 includes a model ID or a model index of an AI model which is included or not included in the set of AI models.

In some embodiments, in the case that information #2 indicates handling the set of AI models, information #2 includes at least one of the following:
(1) Keeping an AI model within the set of AI models. In an embodiment, the keeping an AI model within the set of AI models further includes:
   a) keeping all of the set of AI models; or
   b) keeping one or more AI models within the set of AI models.
(2) Updating an AI model within the set of AI models. In an embodiment, the updating an AI model within the set of AI models further includes:
   a) updating all of the set of AI models; or
   b) updating one or more AI models within the set of AI models.
(3) Deleting an AI model within the set of AI models. In an embodiment, the deleting an AI model within the set of AI models further includes:
   a) deleting all of the set of AI models; or
   b) deleting one or more AI models within the set of AI models.
(4) Falling back an AI model within the set of AI models to a corresponding default AI model. In an embodiment, the falling back an updated AI model within the set of AI models to a corresponding default AI model further includes:
   a) falling back all updated AI model(s) within the set of AI models to corresponding default AI model(s) respectively; or
   b) falling back one or more updated AI models within the set of AI models to one or more corresponding default AI models respectively.

In some embodiments, in the case that information #2 indicates keeping or updating or falling back an AI model within the set of AI models, information #2 further indicates at least one of the following: (1) a time period to maintain a remained AI model corresponding to the AI model; or (2) one or more cell IDs, to which the remained AI model is applicable.

In some embodiments, in the case that information #2 indicates updating an AI model within the set of AI models, information #2 further indicates an updated part to be applied to each of one or more AI models within the set of AI models. In an embodiment, information #2 further indicates one or more model IDs or model indexes of the one or more AI models.

In some embodiments, the UE may transmit, to the network node, information to indicate that one or more AI models at the UE are ready to be used. In an embodiment, the information includes a model ID or a model index of each AI model of the one or more AI models.

In some embodiments, the UE may receive, from the network node, an indication to activate a subset of AI models within the one or more AI models. In some embodiments, the UE may receive, from the network node, one or more model IDs or model indexes of one or more AI models that are expected to be used by the UE.

In some embodiments, information #2 is included in an RRC message (e.g. an RRC release message) to instruct the UE to enter an RRC inactive state or an RRC idle state from an RRC connected state.

In some embodiments, a default AI model and an AI model based on the default AI model have a same model ID or a same model index.

In some embodiments, for one or more AI models available at the UE but not indicated in the second information, the processor is configured to: decide whether to keep, update, delete, or fallback the one or more AI models upon an implementation of the UE; keep all of the one or more AI models by default; update all of the one or more AI models by default; delete all of the one or more AI models by default; or fallback all of the one or more AI models to default AI models.

It should be appreciated by persons skilled in the art that the sequence of the operations in exemplary procedure 400 may be changed and some of the operations in exemplary procedure 400 may be eliminated or modified, without departing from the spirit and scope of the disclosure. Details described in all other embodiments of the present application are applicable for the embodiments of FIG. 4. Moreover, details described in the embodiments of FIG. 4 are applicable for all the embodiments of FIGS. 1-3 and 5-9.

Some other embodiments of the present application provide an exemplary flowchart of AI model management, which may be performed by a network node (e.g. BS 101 as shown in FIG. 1 or BS 802 as shown in FIG. 8). Although described with respect to a network node, it should be understood that other devices may be configured to perform a similar method. Details described in all other embodiments of the present application are applicable for this exemplary flowchart. Moreover, details described in this exemplary flowchart are applicable for all the embodiments of FIGS. 1-9.

In particular, in this exemplary flowchart, a network node may receive information related to an AI model available at a UE from the UE, wherein the information includes a model ID or a model index of the AI model. In some embodiments, the information further includes any of: (1) an updated part of the AI model updated based on a corresponding default AI model; or (2) an indication for indicating that the UE decides to fall back the AI model to the corresponding default AI model.

In some embodiments, the network node may transmit, to the UE, information to confirm that the UE is allowed to use one or more AI models which are ready to be used. In some embodiments, the network node may receive, from the UE, information to indicate that the one or more AI models are ready to be used. A specific example is described in embodiments of FIG. 8 as follows.

Some additional embodiments of the present application provide an exemplary flowchart of AI model management, which may be performed by a UE (e.g. UE 102 as shown in FIG. 1 or UE 801 as shown in FIG. 8). Although described with respect to a network node, it should be understood that other devices may be configured to perform a similar method. Details described in all other embodiments of the present application are applicable for this exemplary flowchart. Moreover, details described in this exemplary flowchart are applicable for all the embodiments of FIGS. 1-9.

In particular, in this exemplary flowchart, a UE may transmit information related to an AI model available at the UE to a network node, wherein the first information includes a model ID or a model index of the AI model. In some embodiments, the information further includes at least one of: (1) an updated part of the AI model updated based on a corresponding default AI model; or (2) an indication for indicating that the UE decides to fall back the AI model to the corresponding default AI model.

In some embodiments, the UE may receive information, which confirms that the UE is allowed to use one or more AI models which are ready to be used, from the network node. In some embodiments, the UE may transmit information, which indicates that the one or more AI models are ready to be used, to the network node. A specific example is described in embodiments of FIG. 8 as follows.

FIG. 5 illustrates a flowchart of an exemplary procedure for AI model management according to some embodiments of the present application. The exemplary procedure 500 as shown in FIG. 5 assume that UE 501 is in an RRC connected state and is using an AI/ML model (which can be either a default model or finetuned/updated by UE 501 or BS 502) for physical layer operation.

In the embodiments of FIG. 5, BS 502 may want to transfer UE 501 from an RRC connected state to an RRC inactive or idle state due to no uplink (UL) or downlink (DL) traffic. UE 501 may be transferred from an RRC connected state to an RRC inactive state or an RRC idle state.

In the exemplary procedure 500, in operation 511, BS 502 may transmit information, e.g. in an RRC release message, to UE 501. The information (e.g. information #2 as described in the embodiments of FIG. 3) may indicate any of the following:
(1) Model ID(s) or index(es) of AI/ML model(s) that UE 501 shall keep. The AI/ML model(s) may include default AI/ML model(s) or AI/ML model(s) after update (e.g. finetuning or adaptation).
(2) Model ID(s) or index(es) of AI/ML model(s) that UE 501 shall update.
(3) Model ID(s) or index(es) of AI/ML model(s) that UE 501 shall delete.
(4) Model ID(s) or index(es) of AI/ML model(s) that UE 501 shall fallback to default AI/ML model(s). During falling back an AI/ML model to a default AI/ML model, UE 501 may keep the corresponding default AI/ML model and delete any updated part (e.g. a delta part) if the AI/ML model has been finetuned or updated (e.g. an updated model). In some embodiments, a Model ID or a Model index of an updated model is the same as a Model ID or a Model index of the related default model.
(5) UE 501 shall keep all the AI/ML model(s) available at UE 501.
(6) UE 501 shall delete all the AI/ML model(s) available at UE 501.
(7) UE 501 shall fallback all the AI/ML model(s) to default model(s), e.g. by keeping all the default AI/ML model(s) and deleting the updated part(s) (i.e. delta part(s)) if any AI/ML model(s) has been finetuned or updated.

In some embodiments of FIG. 5, whether BS 502 indicates UE 501 to keep or delete an AI/ML model may depend on if the same AI/ML model is expected to be still valid or applicable to future scenarios. For example, UE 501 may connect to another cell using a different frequency in the future, and BS 502 may determine that the same AI/ML model(s) is not expected to be applicable to future scenarios.

In operation 512, UE 501 may keep, update, delete, or fallback the AI/ML model(s) which is available at UE 501 according to the information received in operation 511.

In some embodiments of FIG. 5, for the AI/ML model(s) that is available at UE 501 but BS 502 didn't explicitly indicate how UE 501 handles such AI/ML model(s) (e.g. nothing relevant is indicated in the RRC release message in operation 511), UE 501 may:
(1) decide whether to keep or update or delete or fallback such AI/ML model(s) upon UE 501's implementation; or
(2) by default, UE 501 will delete all of such AI/ML model(s); or
(3) by default, UE 501 will keep all of such AI/ML model(s); or
(4) by default, UE 501 will fallback all of such default AI/ML model(s) to default model(s), e.g. by keeping the corresponding default model(s) and delete any delta part if such default AI/ML model(s) has been finetuned or updated.

In some embodiments of FIG. 5, BS 502 may further indicate the condition, e.g. in operation 511, for the case that UE 501 is going to keep AI/ML model(s) (either keeping the AI/ML model(s) or only keeping the default model(s)). For instance, the condition may be any of the following:
(1) A time period to maintain an AI model that has been handled by UE 501. For example, if UE 501 stays in an RRC inactive or idle state longer than the time period, UE 501 need to delete the AI model which has been handled by UE 501.
(2) Cell ID(s), to which the AI model that has been handled by UE 501 is applicable. For example, the condition includes cell ID(s) of certain cell(s), and UE 501 may be connected to such cell(s) when entering an RRC connected state again.

In some embodiments of FIG. 5, if the condition to keep a certain AI/ML model is no longer met, UE 501 will either delete the AI/ML model completely or fallback the AI/ML model to a corresponding default model and delete any delta part.

For example, if an AI/ML model which has been finetuned or updated by BS 502 can be used as long as UE 501 connects to some cells belonging to the same BS, BS 502 will give a list of those cells to UE 501. When UE 501 enters an RRC connected state and connects to a new cell, UE 501 will firstly check if the new cell belonging to the list of cells that the AI/ML model is still applicable. If not, UE 501 will delete the AI/ML model completely or fallback it to the corresponding default model and delete any delta part. The time point when UE 501 performs the above mentioned checking and possible deletion could be before UE 501 triggers a random access channel (RACH) procedure to enter an RRC connected state, or when UE 501 successfully enters the RRC connected state, or any time point between these two time points.

In some embodiments of FIG. 5, when BS 502 or UE 501 decides to keep or delete any AI/ML model, BS 502 and UE 501 need to also make sure that a total number of AI/ML models stored at UE 501 fulfils the capability restriction of UE 501, e.g. less than the maximum memory size for AI/ML model that UE 501 can keep in an RRC inactive or idle state. Otherwise, UE 501 may keep the first K AI/ML models with higher priority (each model may be associated with a priority value) which also fulfil the capability limitation of UE 501. K is an integer (pre-)configured or of a default value. Alternatively, UE 501 may only keep default models and delete delta part(s) of the AI/ML model to fulfil the capability limitation of UE 501.

FIG. 6 illustrates a further flowchart of an exemplary procedure for AI model management according to some embodiments of the present application. The embodiments of FIG. 6 refer to a BS initiated default AI/ML model transfer scenario and an AI/ML model handling (e.g. finetune or update or fallback) scenario.

In the embodiments of FIG. 6, when UE 601 is in an RRC connected state, BS 602 transfers default AI/ML model(s) to UE 601 or handle (e.g. keep or delete or finetune or update or fallback) AI/ML model(s) at UE 601 based on the understanding of which AI/ML model are available at UE 601 now. In the exemplary procedure 600 as shown in FIG. 6, BS 602 may understand AI/ML model(s) available at UE 601 via any of the following ways.

In some other embodiments, in operation 611, BS 602 sends a message requesting the available AI/ML model(s) information at UE 601, e.g. via dedicated RRC signaling (e.g. UE Information Request, or a new RRC message). In operation 612, UE 601 sends information (e.g. information #1 as described in the embodiments of FIG. 5) related to a set of AI models available at UE 601 back to BS 602, e.g. via RRC signaling (e.g. a UE Information Response message, a new RRC message, or an indication of the capability of UE 601).

In some further embodiments, different from operations 611 and 612, if UE 601 enters an RRC connected state from an RRC idle state, BS 602 may get information related to available AI/ML model(s) (e.g. information #1 as described in the embodiments of FIG. 5) from a CN. For instance, an indication of the capability of UE 601 is stored at the CN when UE 601 enters an RRC idle state, and the CN sends the indication of the capability of UE 601 to BS 602 when UE 601 enters an RRC connected state again.

In some embodiments of FIG. 6, when BS 602 receives the information related to available AI/ML model(s) from either UE 601 or the CN, the information contains at least Model ID(s) or index(es) and optionally contains delta part(s), if the AI/ML model(s) has been finetuned or updated or if the finetuned or updated AI/ML model(s) is expected to be continuously used in the future. If only the Model ID(s) or index(es) is provided, BS 602 may consider that UE 601 has only default model(s) for the concerned Model ID(s) or index(es) available in the information.

In some embodiments of FIG. 6, BS 602 may decide to transfer default AI/ML model(s) that are not available at UE 601 yet. Each default AI/ML model is identified by a Model ID or a Model index. In some embodiments, in operation 613, BS 602 may transfer parameters of default AI/ML model(s) that are not available at UE 601 to UE 601.

In some embodiments of FIG. 6, BS 602 may decide to handle (e.g. keep or delete or finetune or update or fallback) an AI/ML model at UE 601 based on measurement and monitoring result(s) at BS 602 or based on monitoring result(s) reported by UE 601 or based on handling (e.g. keep or delete or finetune or update or fallback) initiated by other UEs (e.g. as explained in the embodiments of FIG. 8). In some embodiments, in operation 613, BS 602 may send any of the following:
(1) Model ID(s) or index(es) and delta part(s) on top of the corresponding default AI/ML model; or
(2) Model ID(s) or index(es) and delta part(s) on top of an AI/ML model which may have been finetuned or updated already; or
(3) Model ID(s) or index(es) and an indicator indicating UE 601 to fallback an AI/ML model to the corresponding default model.

In some embodiments, in operation 613, BS 602 may indicate UE 601 to keep or delete or fallback certain AI/ML model(s) (identified by a Model ID or a Model index), for example, by transmitting information (e.g. information #2 as described in the embodiments of FIG. 3) to indicate any of the following:
(1) Model ID(s) or index(es) of AI/ML model(s) that UE 601 shall keep. The AI/ML model(s) may include default AI/ML model(s) or AI/ML model(s) after update (e.g. finetuning or adaptation).
(2) Model ID(s) or index(es) of AI/ML model(s) that UE 601 shall update.
(3) Model ID(s) or index(es) of AI/ML model(s) that UE 601 shall delete.
(4) Model ID(s) or index(es) of AI/ML model(s) that UE 601 shall fallback to default AI/ML model(s).
(5) UE 601 shall keep all the AI/ML model(s) available at UE 601.
(6) UE 601 shall delete all the AI/ML model(s) available at UE 601.
(7) UE 601 shall fallback all the AI/ML model(s) to default model(s), e.g. by keeping all the default AI/ML model(s) and deleting the updated part(s) (i.e. delta part(s)) if any AI/ML model(s) has been finetuned or updated.

For AI/ML model(s) that BS 602 didn't explicitly indicate whether UE 601 will use or keep, UE 601 will by implementation or by default decide whether to keep or delete or fallback the AI/ML model(s). For example, UE 601 may:
(1) decide whether to keep or update or delete or fallback such AI/ML model(s) upon UE 601's implementation; or
(2) by default, UE 601 will delete all of such AI/ML model(s); or
(3) by default, UE 601 will keep all of such AI/ML model(s); or
(4) by default, UE 601 will fallback all of such default AI/ML model(s) to default model(s), e.g. by keeping the corresponding default model(s) and delete any delta part if such default AI/ML model(s) has been finetuned or updated.

In some embodiments, in operation 613, BS 602 may indicate UE 601 a list of Model ID(s) or index(es) that are expected to be used when UE 601 is connected to BS 602. UE 601 is expected to adjust or deploy or validate those AI/ML model(s) so that they are ready to be used. In such case, UE 601 may not monitor the performance of other AI/ML model(s) even if they are still kept at UE 601.

In some embodiments of FIG. 6, when BS 602 decides to keep or delete any AI/ML model, BS 602 needs to also make sure that a total number of AI/ML models stored at UE 601 fulfils the capability restriction of UE 601, e.g. less than the maximum memory size for AI/ML model that UE 601 can keep in an RRC connected state. Otherwise, UE 601 shall keep the first K AI/ML models with higher priority (each model may be associated with a priority value) which also fulfil the capability limitation of UE 601. Alternatively, UE 601 only keep default AI/ML models and delete the delta part of the AI/ML model to fulfil the capability limitation of UE 601.

All the above mentioned information that may be transmitted in operation 613 could be sent in the same message or separate messages.

In operation 614, after receiving parameters of default AI/ML model(s) or AI/ML model handling instruction, UE 601 will apply or deploy or validate the concerned AI/ML model(s) accordingly. In operation 615, UE 601 may send a confirmation message to BS 602 (e.g. an RRC message or a MAC CE or DCI), so that BS 602 is aware that some AI/ML model(s) are ready to be used. The confirmation message may contain Model ID(s) or index(es) of AI/ML model(s) that are ready to be used. Otherwise, BS 602 may consider that all AI/ML model(s) are ready to be used. Among the AI/ML model(s) ready to used, BS 602 may further activate any specific AI/ML model(s) via separate signaling.

FIG. 7 illustrates another flowchart of an exemplary procedure for AI model management according to some embodiments of the present application. The exemplary procedure 700 as shown in FIG. 7 refers to a handover scenario. Handover can be considered as a special case of BS initiated default model transfer and model handling (e.g. keep or delete or finetune or update or fallback).

In the exemplary procedure 700 as shown in FIG. 7, if UE 701 is handed over from source BS 702 to target BS 703, target BS 703 may get information related to AI/ML model(s) available at UE 701 from source BS 702, e.g. via the Handover Preparation procedure over Xn interface.

In some embodiments of FIG. 7, in operation 711, source BS 702 may transmit information related to AI/ML model(s) available at UE 701 (e.g. information #1 as described in the embodiments of FIG. 3), e.g. which may be included in a handover request, to target BS 703. For example, the transmitted information contains at least Model ID(s) or index(es) and optionally contains delta part(s), if the AI/ML model(s) has been finetuned or updated or if the finetuned or updated AI/ML model(s) is expected to be continuously used in the future. If only the Model ID(s) or index(es) is provided, target BS 703 may consider that UE 701 has only default model(s) for the concerned Model ID(s) or index(es) available in the information. In some embodiments, target BS 703 does not need to know the finetuned or updated AI/ML model(s) that has been used by source BS 702 before, since these two BSs could belong to different vendors and concerned cells could use different frequencies or carriers.

In some other embodiments of FIG. 7, if UE 701 enters an RRC connected state from an RRC inactive state, target BS 703 may get the information related to available AI/ML model(s) from source BS 702 via a UE Context Retrieve procedure over Xn interface. The information may be received over Xn interface via the UE context retrieve procedure when UE 701 enters an RRC connected state from an RRC inactive state or via a handover preparation procedure.

In operation 712, target BS 703 may transmit a Handover Request Acknowledge message to source BS 702, e.g. over Xn interface, including at least one of the information that may be transmitted in operation 613 as described in the embodiments of FIG. 6. In operation 713, source BS 702 transfers the above mentioned information included in the Handover Request Acknowledge message to UE 701 via Uu interface.

FIG. 8 illustrates an additional flowchart of an exemplary procedure for AI model management according to some embodiments of the present application. The embodiments of FIG. 8 refer to a UE initiated AI/ML model handling (e.g. finetune or update or fallback) scenario.

In the exemplary procedure 800 as shown in FIG. 8, UE 801 may decide to handle (e.g. finetune or update or fallback) the current AI/ML model(s) based on local measurement or monitoring result(s). For instance, in operation 811, UE 801 may inform BS 802 about the AI/ML model finetuning or updating or falling back via a dedicated message over air interface. For instance, UE 801 may send at least one of (1) a model ID or a model index and a delta part of the AI/ML model for finetuning or updating, or (2) a model ID or a model index and an indicator indicating UE decides to fallback the AI/ML model to the corresponding default model.

In some embodiments of FIG. 8, after UE 801 sends the above mentioned handling (e.g. finetune or update or fallback) information, UE 801 will wait for confirmation from BS 802 before starting to use the AI/ML model after handling (e.g. finetuning or update or fallback). For instance, in operation 812 (optional), BS 802 may transmit, to UE 801, information to confirm that UE 801 is allowed to use one or more AI models which are ready to be used. In this case, it is upon BS 802 to finally decide whether the updated AI/ML model can be used as UE 801 suggested.

In some embodiments of FIG. 8, UE 801 may send information after UE 801 has already deployed and started using the AI/ML model after handling (e.g. finetune or update or fallback). For instance, in operation 813 (optional), UE 801 may transmit, to BS 802, information to confirm that one or more AI models at UE 801 are ready to be used according to the information in operation 812. In this case, UE 801 has the full decision on the AI/ML model usage, while BS 802 still needs to be aware of the AI/ML model usage decided by UE 801.

FIG. 9 illustrates a block diagram of an exemplary apparatus 900 in accordance with some embodiments of the present application. As shown in FIG. 9, the apparatus 900 may include at least one processor 906 and at least one transceiver 902 coupled to the processor 906. Although in this figure, elements such as the at least one transceiver 902 and processor 906 are described in the singular, the plural is contemplated unless a limitation to the singular is explicitly stated. In some embodiments of the subject application, the transceiver 902 may be divided into two devices, such as a receiving circuitry and a transmitting circuitry. In some embodiments of the subject application, the apparatus 900 may further include an input device, a memory, and/or other components.

In some embodiments of the subject application, the apparatus 900 may be a UE or a network node (e.g. a BS, a source BS, or a target BS). The transceiver 902 and the processor 906 may interact with each other so as to perform the operations with respect to the UE or the network node described above, for example, in any of FIGS. 1-8.

In some embodiments of the subject application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to a UE or a network node (e.g. a BS, a source BS, or a target BS) as described above. For example, the computer-executable instructions, when executed, cause the processor 906 interacting with transceiver 902 to perform the operations with respect to the UE or the network node described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A network node for wireless communication, comprising:
at least one memory; and
at least one processor coupled with the at least one memory and configured to cause the network node to:
receive first information related to a set of artificial intelligence (AI) models available at a user equipment (UE); and
transmit second information indicating at least one of an AI model that is not included in the set of AI models or handling information for the set of AI models.

2. The network node of claim 1, wherein:
the AI model that is not included in the set of AI models is a default AI model, or an AI model updated based on a corresponding default AI model; and
if the AI model that is not included in the set of AI models is the AI model updated based on the corresponding default AI model, the second information further comprises an updated part of the AI model that is not included in the set of AI models.

3. The network node of claim 1, wherein the first information is received from another network node.

4. The network node of claim 1, wherein, if the second information indicates handling the set of AI models, the second information indicates at least one of:
keeping an AI model within the set of AI models;
updating an AI model within the set of AI models;
deleting an AI model within the set of AI models; or
falling back from an AI model within the set of AI models to a corresponding default AI model.

5. The network node of claim 4, wherein:
the keeping the AI model within the set of AI models further includes keeping all of the set of AI models, or keeping one or more AI models within the set of AI models;
the updating the AI model within the set of AI models further includes updating all of the set of AI models, or updating one or more AI models within the set of AI models;
the deleting the AI model within the set of AI models further includes deleting all of the set of AI models, or deleting one or more AI models within the set of AI models; and
the falling back from the AI model updated within the set of AI models to a corresponding default AI model further includes falling back from respective updated one or more AI models within the set of AI models to corresponding default AI models, or falling back from respective one or more AI models updated within the set of AI models to one or more corresponding default AI models.

6. The network node of claim 4, wherein, if the second information indicates keeping or updating or falling back from the AI model within the set of AI models, the second information further indicates at least one of:
a time period to maintain a remaining AI model corresponding to the AI model; or
one or more cell identifiers (IDs), to which the remaining AI model is applicable.

7. The network node of claim 4, wherein, if the second information indicates the updating the AI model within the set of AI models, the second information further indicates an updated part to be applied to each of one or more AI models updated within the set of AI models.

8. The network node of claim 4, wherein a default AI model is identified by a dedicated model identifier (ID) or a dedicated model index, and any AI model updated based on the default AI model is identified by the dedicated model ID or the dedicated model index that has been used to identify the default AI model.

9. The network node of claim 1, wherein the at least one processor is configured to cause the network node to receive, from the UE, information to confirm that one or more AI models at the UE are ready to be used according to the second information.

10. The network node of claim 1, wherein the second information is included in a radio resource control (RRC) message to instruct the UE to enter an RRC inactive state or an RRC idle state from an RRC connected state.

11. A user equipment (UE) for wireless communication, comprising:
at least one memory; and
at least one processor coupled with the at least one memory and configured to cause the UE to:
transmit, to a network node, first information related to a set of artificial intelligence (AI) models available at the UE; and
receive, from the network node, second information indicating at least one of an AI model that is not included in the set of AI models or handling information for the set of AI models.

12. A user equipment (UE) for wireless communication, comprising:
at least one memory; and
at least one processor coupled with the at least one memory and configured to cause the UE to transmit, to a network node, information related to an artificial intelligence (AI) model available at the UE, wherein the information includes a model identifier (ID) or a model index of the AI model.

13. The UE of claim 12, wherein the information further includes at least one of:
an updated part of the AI model updated based on a corresponding default AI model; or
an indication that the UE falls back from the AI model to a corresponding default AI model.

14. The UE of claim 12, wherein the at least one processor is configured to cause the UE to receive, from the network node, information to confirm that the UE is allowed to use one or more AI models which are ready to be used.

15. The UE of claim 14, wherein the at least one processor is configured to transmit, to the network node, information to indicate that the one or more AI models are ready to be used.

16. A method performed by a network node, the method comprising:
receiving first information related to a set of artificial intelligence (AI) models available at a user equipment (UE); and
transmitting second information indicating at least one of an AI model that is not included in the set of AI models or handling information for the set of AI models.

17. The method of claim 16, wherein:
the AI model that is not included in the set of AI models is a default AI model, or an AI model updated based on a corresponding default AI model; and
if the AI model that is not included in the set of AI models is the AI model updated based on the corresponding default AI model, the second information further comprises an updated part of the AI model that is not included in the set of AI models.

18. The method of claim 16, wherein, if the second information indicates handling the set of AI models, the second information indicates at least one of:
keeping an AI model within the set of AI models;
updating an AI model within the set of AI models;
deleting an AI model within the set of AI models; or
falling back from an AI model within the set of AI models to a corresponding default AI model.

19. The method of claim 16, further comprising:
receiving, from the UE, information to confirm that one or more AI models at the UE are ready to be used according to the second information.

20. The method of claim 16, wherein the second information is included in a radio resource control (RRC) message to instruct the UE to enter an RRC inactive state or an RRC idle state from an RRC connected state.
